(19) United States
(12) Patent Application Publication
(10) Pub. No.: US 2014/0280133 A1
(43) Pub. Date: Sep. 18, 2014

(54) Structured Data to Aggregate Analytics

(71) Applicant: Google Inc., Mountain View, CA (US)

(72) Inventor: Daniel W. Dulitz, Los Altos, CA (US)

(73) Assignee: Google Inc., Mountain View, CA (US)

(21) Appl. No.: 14/061,827

(22) Filed: Oct. 24, 2013

Related U.S. Application Data
(60) Provisional application No. 61/780,200, filed on Mar. 13, 2013.

(51) Int. Cl. G06F 17/30

(52) U.S. Cl. CPC G06F 17/30386
USPC 707/736

(57) ABSTRACT

Methods, systems, and apparatus, including computer programs encoded on a computer storage medium, for obtaining first user interaction data corresponding to a user's interaction with a web resource, identifying structured data included in the web resource, identifying an entity referenced by the structured data included in the web resource, and associating the first user interaction data with the entity.

### CROSS-REFERENCE TO RELATED APPLICATION

This application claims the benefit of U.S. Provisional Pat. App. No. 61/780,200, filed Mar. 13, 2013, which is incorporated herein by reference.

### BACKGROUND

This specification generally relates to providing analytical data regarding user interactions with Internet-assessable web resources.

Users can interact with web resources in a variety of ways. User interactions can provide information about how engaged a user may be with the content provided by the web page. For example, a user may visit a web page by entering a query in a search engine application and selecting on a link to a web page for a search result. Once the web page is presented to the user, e.g., displayed on a display of a user's computing device, the user can spend a measurable amount of time, e.g., a “dwell time,” reviewing the web page content.

The user can then click on links included in the web page to access other, and in many cases, related web pages. The user may then click on a link included on the other web page to get back to the original web page they were viewing. Each click can be considered a user interaction with the associated web page. Web resource providers can record and aggregate the click data and the dwell time data, using these analytics to determine a level of user engagement with a web page. Longer dwell times and large number of clicks can indicate a strong level of engagement with a web resource.

### SUMMARY

Analytics for a web resource, e.g., a web page, an image, a text document, multimedia content, can give a web resource provider insight into how users interact with the web resource. In some cases, the analytics can be associated with a Uniform Resource Locator (URL) for the web resource. In some cases, the analytics can be associated with specific metadata defined by and added to the metadata for the web resource by the web resource provider. In these cases, the web resource provider can markup their web pages with the specific metadata that has meaning only to the web resource provider.

In some implementations, a web resource provider may markup their web pages in ways that can also be recognized by search system providers. A search system can use the markup data to improve the display of search results enabling users of the search systems to more easily navigate to the information they are searching for. Many web resources include references to one or more entities. These references can be included in the metadata for the web resource.

For example, an entity can be a place, e.g., the White House, and the web resource can include one or more references to the entity, e.g., an address “1600 Pennsylvania Avenue”, a zip code “50500”. An entity identifier can be assigned to each entity, e.g., the White House, the White House address, the White House zip code, or to a group of entities, e.g., the White House and any entity that includes information about the White House, such as the address and the zip code. User interaction data with a web page can be associated with the entity associated with the web page. A web resource provider can use the analytics to better understand user interactions with web pages associated with an entity. In this example, the web resource provider can review data for how much time users spent reviewing web pages about the White House and how many users visited web pages about the White House. In some cases, different web pages that included information about the White House, and other possible related entities, can be benchmarked with respect to dwell time and user visits.

In general, one innovative aspect of the subject matter described in this specification can be embodied in methods that include the actions of obtaining first user interaction data corresponding to a user's interaction with a web resource, identifying structured data included in the web resource, identifying an entity referenced by the structured data included in the web resource, and associating the first user interaction data with the entity.

Other embodiments of this aspect include corresponding systems, apparatus, and computer programs, configured to perform the actions of the methods, encoded on computer storage devices.

These and other implementations can each optionally include one or more of the following features. The actions can further include obtaining second user interaction data corresponding to a user's interaction with an other web resource, identifying structured data included in the other web resource, identifying an other entity referenced by the structured data included in the other web resource, determining whether the other entity is the same as the entity, and based on determining that the other entity is the same as the entity, associating the second user interaction with the entity. Associating the first user interaction data with the entity includes associating the first user interaction data with an entity identifier for the entity, determining whether the other entity is the same as the entity comprises determining that an entity identifier for the other entity is the same as the entity identifier for the entity, and associating the second user interaction data with the entity comprises associating the second user interaction data with the entity identifier for the entity. The user interaction is one of a click, or a dwell time. The structured data is a set of definitions that define metadata associated with the web resource, the set of definitions assigned by a provider of the web resource. The metadata includes data indicative of one or more entities associated with the structured data. The structured data is a collection of schemas used to markup the web resource by a provider of the web resource. The collection of schemas are implemented as Hypertext Markup Language (HTML) tags. The actions can further include generating analytical data for the entity based at least in part on the first user interaction data and the second user interaction data. Generating the analytical data for the entity includes aggregating user interaction data associated with the entity for user interactions with a plurality of web resources. Generating the analytical data for the entity includes identifying analytical data for the entity for a plurality of web resources, where the analytical data for the entity is based on user interactions with the plurality of web resources, determining an average of the analytical data for the entity for each of the plurality of web resources, and comparing the analytical data for the entity for a one of the plurality of web resources to the an average of the analytical data for the entity.

Particular embodiments of the subject matter described in this specification can be implemented so as to realize one or more of the following advantages. The use of structured data in a markup language for a web page allows for the association of user interactions with a web page with various analytics for the web page. The structured data can include entities that provide identification of the content of the web page. The user interaction data can be associated with identifiers for the entities. User interactions with web pages that include a particular content can be determined based on the entity identifiers. The analytics can be further used to determine the popularity of a web page by how often users visit the web page and how long users spend viewing the web page.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example system that can execute implementations of the present disclosure.

FIG. 2 is an example table that shows how a system records user interaction data with web pages.

FIG. 3A is an example table that shows total dwell times, average dwell times, and total frequency counts associated with entity identifiers (IDs).

FIG. 3B is an example table that shows aggregated statistics associated with web page navigation.

FIG. 3C is an example graph that shows an average dwell time for multiple web pages whose metadata includes a common entity.

FIG. 3D is an example graph of aggregated data for multiple entities per time.

FIG. 4 is a flow diagram illustrating an example process for associating user interaction data with an entity.

Like reference numbers and designations in the various drawings indicate like elements.

### DETAILED DESCRIPTION

Web resources can include references to one or more entities. These references can be included in the markup for the web resource in order to provide additional data about the web resource. In general, the term “entity” can refer to something that is a discrete unit, for example, a person, place, thing, or idea. A search system can maintain an entity database that stores information about various entities and various relationships between the entities. For example, the search system can store various data about the real world entity Lady Gaga, for example, the text string “Lady Gaga,” a birthdate, a birthplace, a description, resources about the entity, and images, in addition to a variety of other types of information.

The system can assign a unique entity identifier to each entity. The system can also assign one or more text string aliases to a particular entity, which need not be unique among entities. For example, Lady Gaga can be associated with aliases “Lady Gaga” and “Stefani Joanne Angelina Germanotta.”

The system can also store information about the entity's relationship to other entities. For example, the system can define a “birthdate” relationship to reflect that Lady Gaga was born on Mar. 28, 1986. In some implementations, the system stores relationships between entities as a graph in which nodes represent distinct entities and links between nodes represent relationships between the entities. In this example, the system could maintain a node corresponding to the entity Lady Gaga, a node corresponding to the entity Mar. 28, 1986, and a link between the nodes representing that Lady Gaga was born on Mar. 28, 1986.

Web resource providers that maintain web pages that reference entities can use markup languages to enhance the information included in a web page. The markup language can be read and acted upon by a search system, for example. A markup language is a convention for annotating text by syntactically distinguishable elements, e.g., tags. A web resource provider can include text of a particular markup language, in source code for a web page in order to define a structured data item on the web page. The markup language can be Extensible Markup Language (XML), Hypertext Markup Language (HTML), HTML5, or any of a variety of other appropriate markup languages. In some implementations, the markup language data, e.g., metadata, is not necessarily presented or rendered on a user device, and is rather served on web pages only to be parsed and used by search systems.

The markup language can specify a structured data item that can correspond to a real world person, place, thing, or idea, for example. In the above example, one or more structured data items for Lady Gaga can be included in the markup language for a web page. An example of a markup language schema for defining structured data items can be found at http://schema.org.

The following is an example of a structured data item defined by a markup language segment, using the schema from schema.org. The example structured data item shown below in Table 1 corresponds to a camera model and therefore can be included in a web page that references the camera model. The inclusion of the structured data item can signal to a search system that the web page includes structured information describing the camera model.

TABLE 1

<div itemscope itemtype=“http://schema.org/Product”>

<div itemprop=“name”>Acme Model XYZ Digital Camera</div>
<div itemprop=“manufacturer”>Acme</div>
<a itemprop=“url”
href=“http://www.camerastore.com/products/AcmeModelXYZ.html”>
</a>
<div itemprop=“description”>The Acme Model XYZ Digital Camera is ideal

for any photographer, combining both high quality imaging that makes taking
pictures easy. </div>

<div>Product ID: <span itemprop=“productID”>12345678</div>

<div>

The structured data item itself is distinguished from other source code of the web page by “<div>” tags. The “<div>” tags can define an item type, e.g. in this case a “Product,” and can also define various properties of the item. Each property of the item includes a name value pair. In this example, the first “itemprop” attribute indicates a property “name” for the camera, and has a value of “Acme Model XYZ Digital Camera.” The second “itemprop” attribute indicates a property of “url” for the camera, and has a value of http://www.camerastore.com/products/AcmeModeIXYZ.html.

A search system can parse the markup language code for the web page to obtain the structured information about properties of an item, which can influence how the search system processes, indexes, and ranks the web page when providing search results.

This specification describes technologies relating to associating user interaction with a web resource with each of one or more identified entities referenced by the web resource. The user interaction data per specific entity can be aggregated based on particular criteria and used by a web resource provider to allow the provider to better understand user interactions with their web pages. For example, referring to the above example of the structured data item for a camera model, the web resource provider can determine that a user visited a product page on their web site, e.g., Acme Model XYZ camera, as the structured data item for the camera model, e.g., the property “name”, would be included in the metadata for the web page. In addition, the web resource provider can determine that a user visited the product page on their web site, e.g., Acme Model XYZ camera, of by way of a plurality of web pages, e.g., a web page listing digital cameras, a web page listing current cameras on clearance, as the metadata for each web page would include the property “url” along with a structured data item for the Acme Model XYZ camera. For example, a user navigated to a web page for Acme Model XYZ camera by way of a web page that lists digital camera models. Another user navigated to the web page for the Acme Model XYZ camera by way of a web page listing current cameras on clearance.

Information characterizing the navigation paths to the web page for the Acme Model XYZ camera can include the number of times the navigation path was used by users. A common entity associated with all of the web pages that reference the Acme Model XYZ camera can also be associated with a user interaction count that counts the number of user interactions with web pages that are associated with the Acme Model XYZ camera entity. In addition, information characterizing how long a user remained on each web page, e.g., “dwell time”, can be associated with the entity. In some cases, the dwell time data can be used to benchmark web pages in comparison to other web pages that are associated with the Acme Model XYZ camera entity.

FIG. 1 is a diagram of an example system 100 that can execute implementations of the present disclosure. For example, the system 100 can associate one or more entities with a web page by analyzing the metadata for the web page, can gather data about user interactions with the web page, and can associate the user interaction data with each of the one or more entities associated with the web page. In general, the system 100 includes one or more client devices 102a-c that can interact with a web server system 104 by way of network 110 enabling users 104a-c to navigate to web resources.

In the example of FIG. 1, a user, e.g., a user 103a, accesses the web server 104a by way of network 110 in order to navigate to a web page 106a. The web resource provider of web page 106a can store and maintain metadata for web pages in a web server database 104b. The web server 104a can assess the metadata for the web page 106a from the web server database 104b and then provide the metadata for the web page 106a to the client device 102a for display of the web page 106a to the user 103a on a display 124. In a similar manner, users 104b, 104c can access and view web pages on the displays 122, 120 of their respective client devices 102b, 102c.

In this example, the web page 106a includes information about Lady Gaga. The user 103a can navigate to additional web pages 106b, 106c that provide more specific information about Lady Gaga based on a selection of a link identifier 108a, 108b, respectively, for the web page. The identifier can be a link to or URL for the web page. In the case where the user activates link identifier 108a, the web server 104a can retrieve the metadata for the web page 106b from the web server database 104b and provide the metadata to the client device 102a in order to display the content of the web page 106b to the user 103a on the display 124.

An entity server system 112 can parse the markup language for a web page to extract structured data items and to identify various properties and their respective values from the structured data items. An entity database 112b stores information about various entities and various relationships between the entities. The entity database 112b can include two data structures: one that maps each alias to one or more entities, and another that maps an entity to one or more related entities. The two data structures can be implemented, for example, as indices where an entity alias index uses text string aliases as keys and an entity relationship index uses entity identifiers as keys.

The entity server system 112 can identify candidate entities from the structured data item properties, for example, by using the value of each extracted property as input to an entity alias index, included in the entity database 112b, that maps an alias to one or more entities to determine whether the properties of the structured data items correspond to an entity. For example, the entity server system 112 can determine that a parsed string of text for a structured data item is an alias for an entity, e.g., entities 116a-d, that is associated with an entity identifier, e.g., entity identifiers 118a-d, respectively. In this example, the entity server system 112 can determine that the parsed string of text for a structured data item, e.g., <div itemprop=“performer” itemscope itemtype=“http://schema.org/Person”> Performer: <span itemprop=“name”>Lady Gaga</span></div>, is an alias for the entity 116a, Lady Gaga, that is associated with the entity identifier 118a.

In some implementations, the entity alias index can also provide a reference score for each of the candidate entities to which an alias is mapped. The reference score for a candidate entity can represent a likelihood that the alias refers to the given candidate entity. In order to select a candidate entity from multiple candidate entities for a structured data item, the system can adjust scores for the candidate entities based on relationships between the candidate entities and other entities referenced by other properties of the structured data. The entity server system 112 determines whether any properties of the structured data item or text included in the metadata for a web page correspond to related entities. For example, the entity server system 112 can determine that “Acme” is an alias for the entity of a particular camera manufacturer and that the candidate entity has a “manufactured by” relationship with the entity of the camera manufacturer “Acme.” The system can make determinations about entity relationships using an entity relationship index that maps an entity to one or more related entities and includes a link score for each relationship.

The entity server system 112 can also use other text included in the metadata for a web page to disambiguate candidate entities. The entity server system 112 can determine that the text includes occurrences of other entity aliases. For each occurrence of an entity alias in the text, the system can determine whether any of the corresponding entities are related to the candidate entity. The entity server system 112 can compute a modified score for a candidate entity based on respective initial scores for related entities and respective link scores between the candidate entity and the related entities. An initial score for a related entity can represent a likelihood that an alias used to identify the related entity refers to the related entity and can be obtained, for example, from the entity alias index that maps aliases to candidate entities. The link score can represent the significance or importance of the relationship between the candidate entity and the related entity and can be obtained, for example, from an entity relationship index.

In some implementations, the system computes a modifier, M, for each related entity, RE, according to: M=IS[A1,RE]*W[CE,RE], where IS[A1,RE] is the initial score for the related entity, and W[CE,RE] is the link score between the candidate entity CE and the related entity RE.

Once each of the modifiers to the initial score for the candidate entity has been computed, the system can compute a modified score using the initial score for the candidate entities and respective modifiers of entities related to the candidate entity. For example, the system can generate the modified score by adding a sum of the modifiers to the initial score of the candidate entity.

Referring again to FIG. 1, the web page 106a includes structured data items, or metadata, for Lady Gaga tickets, Lady Gaga's biography, and news about Lady Gaga. The metadata can be associated with a Lady Gaga tickets entity, a Lady Gaga biography entity, and a Lady Gaga news entity. In addition, or in the alternative, the metadata for Lady Gaga tickets, Lady Gaga's biography, and news about Lady Gaga can be associated with a single Lady Gaga entity. Web page 106b includes metadata for Lady Gaga tickets and can be associated with the Lady Gaga ticket entity as well as the Lady Gaga entity. Web page 106c includes metadata for news about Lady Gaga and can be associated with the Lady Gaga news entity as well as the Lady Gaga entity. In the example of FIG. 1, the web page 106c includes metadata for Lady Gaga tickets and can be associated with the Lady Gaga ticket entity. A user can activate a link identifier 128 in order to navigate to the web page 106b.

The amount of time a user spends on the viewing of a web page can be referred to as linger or dwell time for the web page. In some cases, the dwell time for one web page can be benchmarked against the dwell time for other web pages. In some examples, a long dwell time for a web page can be indicative of the importance of the content presented by the web page.

The system 100 can gather analytical data about the user's web page visits and interactions. As the user 103a visits and interacts with web pages 106a-c, information characterizing each web page visit and the interactions with each web page can be provided to a web analytics system 114. The web analytics server 114a can record the user 103a's visit to the web page 106a as an increase in a frequency count for each of the one or more entities associated with the web page 106a. As described, a Lady Gaga tickets entity 116b, a Lady Gaga biography entity 116d, a Lady Gaga news entity 116c, and a Lady Gaga entity 116a are associated with the web page 106a. Each entity, e.g., the Lady Gaga tickets entity 116b, the Lady Gaga biography entity 116d, the Lady Gaga news entity 116c, and the Lady Gaga entity 116a, is associated with a respective entity ID 118b, 118d, 118c, and 118a. A web analytics database 114b can include a web analytics table 126 that stores a frequency count and dwell time for each entity ID. In the example, the user 103a's visit to the web page 106a, e.g., a click and view, can increase the frequency count for each entity ID 118a-d associated with the web page 106a, e.g., one is added to the frequency count for the entity. In this example, entities 118a-d would have their associated frequency counts incremented by one. In addition, the dwell time for the user visit to the web page 106a can be added to a dwell time associated with each entity 118a-d associated with the web page 106a.

In some implementations, the dwell time for an entity can be benchmarked against other dwell times for other entities. In the example in FIG. 1, the dwell time for entity ID 118g is the largest. Entity ID 118b is associated with entity 116b, Lady Gaga Tickets. The data in table 126 indicates user's spent the most time viewing web pages that included information about Lady Gaga tickets as compared to web pages that included general Lady Gag information, Lady Gaga's biography and news about Lady Gaga.

In some implementations, the web analytics system 114 can gather data about how a user navigates from one web page to another and record it in the table 126. In the example of FIG. 1, the web analytics system 114 records a user navigating from web page 106a to web page 106b as entity ID 128a, associating the entity 116a with the web page 106a and associating the entity 116b with the web page 106b. The determination of the entity for use in identifying the web page for the navigation entry can be based on a score for the entity for the web page. The score can be determined in a similar manner as the described determination of a reference score for a candidate entity. The system 100 can gather web analytics for all visits to the web pages 106a-c.

In the illustrative example of FIG. 1, the systems 104, 112, and 114 can be implemented as computer programs running on one or more computers, e.g., web server 104a, entity server 112a, and web analytics server 114a, in one or more locations that are coupled to each other and to the client devices 102a-c through a network, e.g., network 110. A database can refer to any collection of data: the data does not need to be structured in any particular way, or structured at all, and it can be stored on storage devices in one or more locations. For example, the web server database 112b, the entity server database 112b, and the web analytics database 114b can include multiple collections of data, each of which may be organized and accessed differently.

The network 110 can include, for example, a wireless cellular network, a wireless local area network (WLAN) or Wi-Fi network, a Third Generation (3G) or Fourth Generation (4G) mobile telecommunications network, a wired Ethernet network, a private network such as an intranet, a public network such as the Internet, or any appropriate combination thereof.

The client devices 102a-c can be any appropriate type of computing device, e.g., mobile phones, tablet computers, notebook computers, music players, e-book readers, laptop or desktop computers, PDAs, smart phones, or other stationary or portable devices, that includes one or more processors and computer readable media. Among other components, the client devices 102a-c include one or more processors, computer readable media that store software applications, e.g., a browser, an input module, e.g., a keyboard or mouse, a communication interface, and a display device, e.g., display devices 124, 122, and 120, respectively.

FIG. 2 is an example table 200 that shows how the system 100 records user interaction data with web pages 106a-c. In the example table 200, the user interaction data comprises a running cumulative frequency count 202, e.g., a click count and a running cumulative dwell time 204 associated with an entity ID 206. For illustrative purposes, a stage entry 208 correlates to the stages A-E shown in FIG. 1 that will be used to describe how the system 100 collects user interaction data for associating with entities and their associated entity IDs.

In general, a cumulative frequency count is a record of the number of times users have accessed web pages that are associated with the entity indicated by the entity ID. A cumulative dwell time is a record of the total amount of time users have spent viewing and interacting with web pages that are associated with the entity indicated by the entity ID.

Referring to both FIG. 1 and FIG. 2, the user 103a wants to purchase tickets to a Lady Gaga concert. During stage A, the user 103a navigates to the web page 106a. For example, the use 104a enters the URL for the web page 106a into a web browser executing on the client device 102a. In another example, the user 103a enters a query for Lady Gaga concert tickets into a search engine. A link to the web page 106a is provided as one of the search results. The user 103a activates the link to navigate to the web page 106a. The web server system 104 provides the metadata for the web page 106a to the client device 102a. The client device 102a displays the web page 106a on the display 124.

The entity server system 112 identifies entities from the structured data for the web page 106a during stage A and associates the identified entities with entity IDs 206a-d. As shown in the table 200, the web page 106a includes a Lady Gaga ticket entity, associated with entity ID 206a (123abc), a Lady Gaga news entity, associated with entity ID 206b (123def), and a Lady Gaga news entity, associated with entity ID 206c (123ghi). In addition, the Lady Gaga ticket entity, the Lady Gaga biography entity, and the Lady Gaga news entity can be associated with the single Lady Gaga entity, associated with entity ID 206d (123).

Cumulative frequency counts 202a-d and cumulative dwell times 204a-d are associated with each entity ID 206a-d, respectively. The dwell times 204a-d are a record of a total amount of time that users have spent reviewing and interacting with web pages whose metadata include entities associated with entity IDs 206a-d. In this example, the dwell times associated with each of the entity IDs 206a-d are increased by the amount of time, ten seconds, user 103a spent reviewing and interacting with web page 106a, resulting in the cumulative dwell times 204a-d. The cumulative frequency counts 202a-d are a record of a running count of the number of clicks or visits that users have made to web pages whose metadata include entities associated with entity IDs 206a-d. In this example, the frequency counts associated with each of the entity IDs 206a-d are increased by one, resulting in the cumulative frequency counts 202a-d.

During stage B, the user 103a activates the link indicator 108a in order to navigate to the web page 106b where the user can interact with the web page 106b and purchase concert tickets. In general, a user can interact with a web page by clicking a pointing device while hovering an indicator corresponding to the pointing device over a link indicator or other type of indicator included in the web page. The clicking of the pointing device while hovering the pointing device indicator over a link indicator will result in the user navigating from the current web page they are viewing to the web page for the URL associated with the link indicator.

The entity server system 112 identifies entities from the structured data for the web page 106b during stage B and associates the identified entities with entity ID 206a. As shown in the table 200, the web page 106b includes a Lady Gaga ticket entity, associated with entity ID 206a (123abc). Cumulative frequency count 202f and cumulative dwell time 204f are associated with entity ID 206a. The dwell time 204f is a record of a total amount of time that users have spent reviewing and interacting with web pages whose metadata include entities associated with entity ID 206a. In this example, the dwell time associated with entity ID 206a is increased by the amount of time, 30 seconds, user 103a spent reviewing and interacting with web page 106b, resulting in the cumulative dwell time 204f. The cumulative frequency count 202f is a record of a running count of the number of clicks or visits that users have made to web pages whose metadata include entities associated with entity ID 206a. In this example, the frequency count associated with entity ID 206a is increased by one, resulting in the cumulative frequency count 202f. In addition, a cumulative frequency count for entity ID 206e (123->123abc) is incremented indicating a user navigated from a web page, e.g., web page 106a, associated with the entity ID 206d (123) to a web page, e.g., web page 106b, associated with the entity ID 206a (123abc), resulting in cumulative frequency count 202e.

During state C, the user 103a can navigate back to the web page 106a. For example, the user 103a can click a button on a mouse while positioning the indicator for the mouse over the link indicator 130. For example, the user 103a decides not to purchase Lady Gaga concert tickets and would like to read more information about Lady Gaga concerts, e.g., the songs she plans to perform, the length of the concert, reviews of past concerts.

Similar to stage A, the dwell times associated with each of the entity IDs 206a-d are increased by the amount of time, seven seconds, user 103a spent reviewing and interacting with web page 106a, resulting in cumulative dwell times 204h-k and the frequency counts associated with each of the entity IDs 206a-d are increased by one, resulting in cumulative frequency counts 202h-k. In addition, a cumulative frequency count for entity ID 206f (123abc->123) is incremented indicating a user navigated from a web page, e.g., web page 106b, associated with the entity ID 206a (123abc) to a web page, e.g., web page 106a, associated with the entity ID 206d (123), resulting in cumulative frequency count 202g.

The user 103a can dwell on web page 106a before deciding to navigate to web page 106c during state D. The user 103a can click a mouse button while positioning the indicator for the mouse over the link indicator 108b.

The entity server system 112 identifies entities from the structured data for the web page 106c during stage D and associates the identified entities with entity IDs 206a-b. As shown in the table 200, the web page 10ca includes a Lady Gaga ticket entity, associated with entity ID 206a (123abc) and a Lady Gaga news entity, associated with entity ID 206b (123def). Cumulative frequency counts 202m-n and cumulative dwell times 204m-n are associated with each entity ID 206a-b, respectively. The dwell times 204am-n are a record of a total amount of time that users have spent reviewing and interacting with web pages whose metadata include entities associated with entity IDs 206a-b. In this example, the dwell times associated with each of the entity IDs 206a-b are increased by the amount of time, 45 seconds, user 103a spent reviewing and interacting with web page 106c, resulting in the cumulative dwell times 204m-n. The cumulative frequency counts 202m-n are a record of a running count of the number of clicks or visits that users have made to web pages whose metadata include entities associated with entity IDs 206a-b. In this example, the frequency counts associated with each of the entity IDs 206a-b are increased by one, resulting in the cumulative frequency counts 202m-n. In addition, a cumulative frequency count for entity ID 206g (123->123def) is incremented indicating a user navigated from a web page, e.g., web page 106a, associated with the entity ID 206d (123) to a web page, web page 106c, associated with the entity ID 206b (123def), resulting in cumulative frequency count 2021.

While viewing the web page 106c, the user 103a may then decide to go web page 106b and purchase concert tickets in state E.

Similar to stage B, the dwell time associated with entity ID 206a is increased by the amount of time, 65 seconds, user 103a spent reviewing and interacting with web page 106b, resulting in the cumulative dwell time 204p. The cumulative frequency count 202p is a record of a running count of the number of clicks or visits that users have made to web pages whose metadata include entities associated with entity ID 206a. In this example, the frequency count associated with entity ID 206a is increased by one, resulting in the cumulative frequency count 202p. In addition, a cumulative frequency count for entity ID 206h (123def->123abc) is incremented indicating a user navigated from a web page, e.g., web page 106c, associated with the entity ID 206b (123def) to a web page, e.g., web page 106b, associated with the entity ID 206a (123abc), resulting in cumulative frequency count 2020.

Table 200 illustrates how the dwell time and frequency counts associated with an entity ID are incremented as a user navigates between web pages. In some implementations, as shown in FIG. 1, a web analytics table 126 can store the cumulative frequency count and cumulative dwell time for each entity ID. A web resource provider can use the data included in the web analytics table 126 to determine how a user interacts with their web pages.

FIGS. 3A-D are examples of various data and analytics for the cumulative frequency count and cumulative dwell time data for each entity ID.

FIG. 3A is an example table 300 that shows total dwell times 302a-d, average dwell times 306a-d, and total frequency counts 304a-d associated with the entity IDs 206a-d, respectively. For example, referring to FIG. 1 and FIG. 2, the web analytics system 114 can determine and maintain cumulative dwell times and cumulative frequency counts associated with entity IDs based on user interactions with web pages and the entities associated with the web pages. The web analytics system 114 can store the data in web analytics database 114b. A web resource provider can use the calculated average dwell times 306a-d to determine a user's average dwell time on a web page whose metadata includes an entity associated with the entity identifier 206a-d. The web resource provider can use the frequency counts 304a-d to determine how often users visit web pages whose metadata includes an entity associated with the entity identifier 206a-d. In this example, referring also to FIG. 1, users spent the longest amount of time, on average, viewing web pages whose metadata included or was associated with the Lady Gaga ticket entity, associated with the entity ID 206b, though users most frequently visited web pages whose metadata included or was associated with the Lady Gaga entity 206a.

FIG. 3B is an example table 320 that shows aggregated statistics associated with web page navigation. For example, referring to FIG. 1 and FIG. 2, the web analytics system 114 can determine and maintain cumulative frequency counts associated with entity IDs based on how users navigate between web pages. The web analytics system 114 can store the data in web analytics database 114b. A web resource provider can use the cumulative frequency counts 322a-d to determine how a user navigates between web pages. In this example, referring also to FIG. 1 and FIG. 2, users most frequently navigate from a web page associated with the Lady Gaga entity ID to a web page associated with the Lady Gaga news entity ID, entity ID 206g. A web resource provider can determine, using the data in table 350, that the more popular navigation path to a web page associated with the Lady Gaga Ticket entity is from a web page associated with the Lady Gaga entity, entity ID 206e, than from a web page associated with the Lady Gaga news entity, entity ID 206h.

FIG. 3C is an example graph 340 that shows an average dwell time 342a-e for multiple web pages whose metadata includes a common entity. In this example, metadata for five web pages 344a-e include an entity associated with the Lady Gaga ticket entity ID. In some cases, the web pages may be provided by a single web resource provider. In other cases, the web pages may be provided by multiple web resource providers. In this example, web page 344d can be the example web page 106b. The graph 340 indicates users spend on average more time on web page 344d than on web pages 344a-c and less time on average than on web page 344e. These analytics can allow a web resource provider to benchmark their web pages against other web pages.

In some implementation, a search engine provider can collect user interaction data for various web pages using the techniques described in this specification, specifically associating one or more entities with a web page by analyzing the metadata for the web page, gathering data about user interactions with the web page, and associating the user interaction data with each of the one or more entities associated with the web page. The search engine provider can let web resource providers know generic information regarding how their web pages that are associated with certain entities compare to other web pages associated with the same entities. For example, referring to FIG. 3C, the search engine provider can inform a web resource provider that users in general spend more time on their web pages associated with the Lady Gaga ticket entity than on many other web pages associated with the Lady Gaga ticket entity.

FIG. 3D is an example graph 360 of aggregated data for multiple entities over time. The example graph 360 shows the frequency of visits per week over a span of 50 weeks for web pages whose metadata includes entities associated with the entity IDs 206a-c. A web resource provider can use the aggregated data to identify trend or patterns in user interactions with web pages whose metadata includes entities associated with the entity IDs 206a-c. For example, knowing Lady Gaga's concert tour schedule for a specific year, the web resource provider can determine from the aggregated data shown in the graph 360 that web pages whose metadata includes a Lady Gaga ticket entity, associated with entity ID 206a (123abc) are visited more frequently as her concert dates approach and less frequently as the concert dates pass.

FIG. 4 is a flow diagram illustrating an example process 400 for associating user interaction data with an entity. The process 400 can be implemented by one or more computer programs installed on one or more computers. The process 400 will be described as being performed by a system of one or more computers. In one example, the system 100 in FIG. 1 can perform the process 400.

User interaction data is obtained in step 402. As described throughout this specification, user interaction data can include data that specifies how long a user views and interacts with a web page, an indication that a user visited a web page, and a record of the navigation path a user took to go from visiting one web page to visiting another web page.

Structured data is identified in step 404. Metadata for a web page can be parsed in order to extract and identify the structured data items included in a markup language for a web page. In addition, various properties and their respective values for the web page are identified from the structured data items.

An entity is identified in step 406. The structured data can be analyzed in order to identify an entity included in the structured data. User interaction is associated with the entity in step 408. The obtained user interaction data is associated with the entity and can be used in analytics for the web page.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media, e.g., multiple CDs, disks, or other storage devices.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program, also known as a program, software, software application, script, or code, can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device, e.g., for purposes of displaying data to and receiving user input from a user interacting with the client device. Data generated at the client device, e.g., a result of the user interaction, can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining first user interaction data corresponding to a user's interaction with a web resource;
identifying structured data included in the web resource;
identifying an entity referenced by the structured data included in the web resource; and
associating the first user interaction data with the entity.

2. The method of claim 1, further comprising:
obtaining second user interaction data corresponding to a user's interaction with an other web resource;
identifying structured data included in the other web resource;
identifying an other entity referenced by the structured data included in the other web resource;
determining whether the other entity is the same as the entity; and
based on determining that the other entity is the same as the entity, associating the second user interaction with the entity.

3. The method of claim 2, wherein:
associating the first user interaction data with the entity comprises associating the first user interaction data with an entity identifier for the entity,
determining whether the other entity is the same as the entity comprises determining that an entity identifier for the other entity is the same as the entity identifier for the entity, and
associating the second user interaction data with the entity comprises associating the second user interaction data with the entity identifier for the entity.

4. The method of claim 1, wherein the user interaction is one of a click, or a dwell time.

5. The method of claim 1, wherein the structured data is a set of definitions that define metadata associated with the web resource, the set of definitions assigned by a provider of the web resource.

6. The method of claim 5, wherein the metadata includes data indicative of one or more entities associated with the structured data.

7. The method of claim 1, wherein the structured data is a collection of schemas used to markup the web resource by a provider of the web resource.

8. The method of claim 7, wherein the collection of schemas are implemented as Hypertext Markup Language (HTML) tags.

9. The method of claim 2, further comprising:
generating analytical data for the entity based at least in part on the first user interaction data and the second user interaction data.

10. The method of claim 9, wherein generating the analytical data for the entity comprises aggregating user interaction data associated with the entity for user interactions with a plurality of web resources.

11. The method of claim 9, wherein generating the analytical data for the entity comprises:
identifying analytical data for the entity for a plurality of web resources, wherein the analytical data for the entity is based on user interactions with the plurality of web resources;
determining an average of the analytical data for the entity for each of the plurality of web resources; and
comparing the analytical data for the entity for a one of the plurality of web resources to the an average of the analytical data for the entity.

12. A computer-readable storage device having stored thereon instructions, which, when executed by a computer, cause the computer to perform operations comprising:
obtaining first user interaction data corresponding to a user's interaction with a web resource;
identifying structured data included in the web resource;
identifying an entity referenced by the structured data included in the web resource; and
associating the first user interaction data with the entity.

13. The device of claim 12, the operations further comprising:
obtaining second user interaction data corresponding to a user's interaction with an other web resource;
identifying structured data included in the other web resource;
identifying an other entity referenced by the structured data included in the other web resource;
determining whether the other entity is the same as the entity; and
based on determining that the other entity is the same as the entity, associating the second user interaction with the entity.

14. The device of claim 13, wherein:
associating the first user interaction data with the entity comprises associating the first user interaction data with an entity identifier for the entity,
determining whether the other entity is the same as the entity comprises determining that an entity identifier for the other entity is the same as the entity identifier for the entity, and
associating the second user interaction data with the entity comprises associating the second user interaction data with the entity identifier for the entity.

15. The device of claim 12, wherein the user interaction is one of a click, or a dwell time.

16. The device of claim 12, wherein the structured data is a set of definitions that define metadata associated with the web resource, the set of definitions assigned by a provider of the web resource.

17. The device of claim 16, wherein the metadata includes data indicative of one or more entities associated with the structured data.

18. The device of claim 12, wherein the structured data is a collection of schemas used to markup the web resource by a provider of the web resource.

19. The device of claim 18, wherein the collection of schemas are implemented as Hypertext Markup Language (HTML) tags.

20. The device of claim 13, the operations further comprising:
generating analytical data for the entity based at least in part on the first user interaction data and the second user interaction data.

21. The device of claim 20, wherein generating the analytical data for the entity comprises aggregating user interaction data associated with the entity for user interactions with a plurality of web resources.

22. The device of claim 20, wherein the operation of generating the analytical data for the entity comprises:
identifying analytical data for the entity for a plurality of web resources, wherein the analytical data for the entity is based on user interactions with the plurality of web resources;
determining an average of the analytical data for the entity for each of the plurality of web resources; and
comparing the analytical data for the entity for a one of the plurality of web resources to the an average of the analytical data for the entity.

23. A system comprising:
one or more computers; and
a computer-readable storage device having stored thereon instructions that, when executed by the one or more computers, cause the one or more computers to perform operations comprising:
obtaining first user interaction data corresponding to a user's interaction with a web resource;
identifying structured data included in the web resource;
identifying an entity referenced by the structured data included in the web resource; and
associating the first user interaction data with the entity.
